(19) United States
(12) Patent Application Publication
(10) Pub. No.: US 2007/0190514 A1
(43) Pub. Date: Aug. 16, 2007

(54) Computerized assessment tool for an educational institution

(76) Inventor: Jorge R. Diaz, Miami, FL (US)

Correspondence Address: LITMAN LAW OFFICES, LTD., P.O. BOX 15035, CRYSTAL CITY STATION, ARLINGTON, VA, 22215, US

(21) Appl. No.: 11/353,184

(22) Filed: Feb. 14, 2006

(51) Int. Cl. G09B 3/00

(52) U.S. Cl. 434/350

(57) ABSTRACT

A computerized method of using an assessment tool for an educational institution having a plurality of divisions, departments, and functional units that promotes assessment in higher education by improving effectiveness, quality, and efficiency in student services and activities. The assessment tool specifically targets student services by looking at how the following areas impact the organization: goal setting, goal accomplishment, satisfaction surveys, benchmarking, institutional quality, professional standards, and cost estimates. The assessment tool is to be carried out on a computer having a memory, processor and an intranet connection.

### BACKGROUND OF THE INVENTION

1. Field of the Invention

The present invention relates to a web-based based computerized assessment tool for an educational institution. The tool specifically targets student services by receiving data and generating reports to determine the impact on the following areas in the educational organization: goal setting, goal accomplishment, satisfaction surveys, benchmarking, institutional quality, professional standards, and cost estimates.

2. Description of the Related Art

Current trends in higher education suggest increased pressures on campus decision makers to reduce or control costs and improve the overall effectiveness and quality of student services. Within this context, decision makers will increasingly ask for evidence that particular services and activities contribute to the overall success of the institution, and that they support specific institutional goals.

To this end, the present invention is a comprehensive web-based intranet technology system for assessment purposes in higher education. Presently, few if any assessment tools exist nationwide to assess student services and activities. At best, there is existing technology to survey student services and activities in departments. These functional services areas can be found in The Book of Professional Standards for Higher Education written by the Council for the Advancement of Standards in Higher Education (CAS).

The primary purpose of the tool is to promote assessment in higher education by improving effectiveness, quality, and efficiency in student services and activities. The tool specifically targets student services by looking at how the following areas impact the organization: goal setting, goal accomplishment, satisfaction surveys, benchmarking, institutional quality, professional standards, and cost estimates.

By the tool documenting graphically and textually the ongoing and yearly results of all these areas, proper evaluation and planning can take place for the next fiscal year.

Planning for future budgets and enhancements of student services and activities in higher education cannot proceed successfully without proper knowledge. Therefore, the tool described herein makes a contribution to assessment of student services and activities in higher education.

Thus, a computerized assessment tool solving the aforementioned problems is desired.

### SUMMARY OF THE INVENTION

The computerized assessment tool for an educational institution having a plurality of divisions, each of the plurality of divisions having a plurality of departments, and each of the plurality of departments having a plurality of functional units. The assessment tool is to be carried out on a computer having a memory, processor and an intranet connection.

A goal setting function allows for inputting a plurality of goal categories defining key strategic areas of a department or a division within an educational institution, the selection of a goal category, inputting at least one goal for the selected goal category, and the inputting a performance indicator related to the input goal.

A goal accomplishment function allows for selecting the previously input goal, inputting a level of completion for the goal, and inputting a level of achievement for the performance indicator related to the goal.

A satisfaction survey function allows for selecting a functional unit within a department and creating a survey for at least one category of individuals served by the functional unit, receiving feedback data from the category of individuals in response to the survey, and the compiling the received feedback data into a composite survey.

A benchmarking function allows for selecting another educational institution for comparison, inputting of a focus area that defines a specific service area of the other educational institution having previous quantifiable results, inputting the previous quantifiable results for the specific service area of the selected educational institution, and inputting the quantifiable results for the specific service area for the educational institution for a first period of time.

An alternative benchmarking function allows for selecting of an association or professional organization, selecting of another educational institution having an equivalent association or professional organization for comparison, inputting a focus area defining a specific service area of the selected other educational institution having previous quantifiable results, inputting previous quantifiable results for the specific service area of the selected other educational institution, and the inputting of quantifiable results for the specific service area for the educational institution for a first period of time.

A structure focused institutional quality function allows for generating a list of departmental quality functions selected from the group consisting of a committee, a standardized process and a planning process, prompting of a response to determine the existence of each of the departmental quality functions, and receiving a user response based on the step of prompting. Additionally, an improvement focused institutional quality function allows for inputting at least one department improvement, inputting a first qualitative result for the improvement for a first period of time, and inputting a second qualitative result for the improvement for a second later period of time. Finally, a results focused institutional quality function allows for inputting a functional area defining an area of service of the department, displaying the department improvement, the receiving input of a quantitative survey value for the department improvement from individuals within the functional area, stakeholders of the functional area, and individuals external to the functional area, and compiling the input quantitative survey values for a tabular display.

A professional standards function allows for selecting predetermined professional standards, selecting a functional area of a department to rate according to the professional standards, inputting a quantitative rating for the functional area according to the professional standards, tabulating the input quantitative rating, and generating an output table based on the tabulated input quantitative ratings.

A cost estimate function allows for selecting a functional area of a department, selecting at least one key valued activity of the functional area of the department, inputting estimated budget amounts for the key valued activity of educational and general expenditures (E & G), auxiliary revenue, grant revenue, and activity and services revenue (A & S), direct and indirect cost estimates, inputting a total number of students served by the key valued activity, calculating a total cost per student served value based on the sum of all estimated budget amounts divided by the total number of students served, and displaying of the calculated total cost per student served value in comparison with another educational institution's total cost per student served value with respect to the key valued activity.

These and other features of the present invention will become readily apparent upon further review of the following specification and drawings.

### BRIEF DESCRIPTION OF THE DRAWINGS

FIG. 1.0 is a representation of a web-based interface screen for the goal setting feature of the present invention.

FIG. 1.1 is a representation of a web-based interface screen for a first goal of the goal setting feature of the present invention.

FIG. 1.1A is a representation of a web-based interface screen for adding a goal within the goal setting feature of the present invention.

FIG. 1.1B is a representation of a web-based interface screen for editing a goal within the goal setting feature of the present invention.

FIG. 2.1 is a representation of a web-based interface screen for a department goal section of a goal accomplishment feature of the present invention.

FIG. 2.1.1 is a representation of a web-based interface screen for a first department goal of a goal accomplishment feature of the present invention.

FIG. 2.2 is a representation of a web-based interface screen for a division goal section of a goal accomplishment feature of the present invention.

FIG. 3.1 is a representation of a web-based interface screen for a learning community section of a satisfaction survey feature of the present invention.

FIG. 3.1.1 is a representation of a web-based interface screen for a statistical survey output section of a satisfaction survey feature of the present invention.

FIG. 4.1 is a representation of a web-based interface screen for an institutional section of a benchmarking feature of the present invention.

FIG. 4.2 is a representation of a web-based interface screen for an association or professional membership section of a benchmarking feature of the present invention.

FIG. 5.0 is a representation of a web-based interface screen for an institutional quality feature of the present invention.

FIG. 5.1 is a representation of a web-based interface screen for a quality of structure section in an institutional quality feature of the present invention.

FIG. 5.2 is a representation of a web-based interface screen for a quality of improvements section in an institutional quality feature of the present invention.

FIG. 5.3 is a representation of a web-based interface screen for a quality of results section in an institutional quality feature of the present invention.

FIG. 6.1 is a representation of a web-based interface screen for a professional standards feature of the present invention.

FIG. 6.2 is a representation of a web-based interface screen for an input screen for one area of a professional standards feature of the present invention.

FIG. 6.3 is a representation of a web-based interface screen for an output screen one professional standards display matrix of the present invention.

FIG. 7.1 is a representation of a web-based interface screen for a cost estimate feature of the present invention.

FIG. 7.2 is a representation of a web-based interface screen for a outputting a cost per student value for a cost estimate feature of the present invention.

FIG. 8.1 is a representation of a web-based interface screen for a first category in a quantitative goals section of an outcome feature of the present invention.

FIG. 8.1.1 is a representation of a web-based interface screen for a first category in a qualitative goals section of an outcome feature of the present invention.

FIG. 8.2 is a representation of a web-based interface screen for a second category in a quantitative survey section of an outcome feature of the present invention.

FIG. 8.3 is a representation of a web-based interface screen for a third category in a quantitative benchmarking section of an outcome feature of the present invention.

FIG. 8.4 is a representation of a web-based interface screen for a fourth category in a quantitative institutional quality section of an outcome feature of the present invention.

FIG. 8.5 is a representation of a web-based interface screen for a fifth category in a quantitative professional standards section of an outcome feature of the present invention.

FIG. 8.6 is a representation of a web-based interface screen for a sixth category in a quantitative cost estimates section of an outcome feature of the present invention.

Similar reference characters denote corresponding features consistently throughout the attached drawings.

### DETAILED DESCRIPTION OF THE PREFERRED EMBODIMENT

The present invention is directed toward a web-based interface assessment tool for an educational institution. Educational assessment is the process of gathering and interpreting information related to students' achievement of learning objectives at various stages through their academic career. Assessment is not a single action but an ongoing process that ideally involves both information-gathering and use of that information as feedback to modify and improve student learning.

At a course level, assessment examines the degree to which the objectives for a specific course are evidenced in student learning. Faculty engage in course assessment by evaluating student performance on assignments, projects, and exams and then fine-tuning their approach in the course to achieve a better outcome. At the institution level, to which this invention is directed, assessment seeks to determine the degree to which broad institutional objectives are being met. The present invention focuses on assessment of an educational institution comprising educational divisions within an institution, departments within those divisions and further functional units within each of those departments.

The following headings are divided into two main categories: assessment data collecting categories and an outcome category. The assessment data collecting categories allow for the input and collection of all assessment data. These categories are Goal Setting, Goal Accomplishments, Satisfaction Survey, Benchmarking, Institutional Quality, Professional Standards and Cost Estimates. Each of these categories may have the capacity to process and output or display the data that is input or collected. The outcome category pulls all the data from the data collecting categories and displays quantitative and qualitative presentations of that data for analysis by the educational institution.

### I. Goal Setting

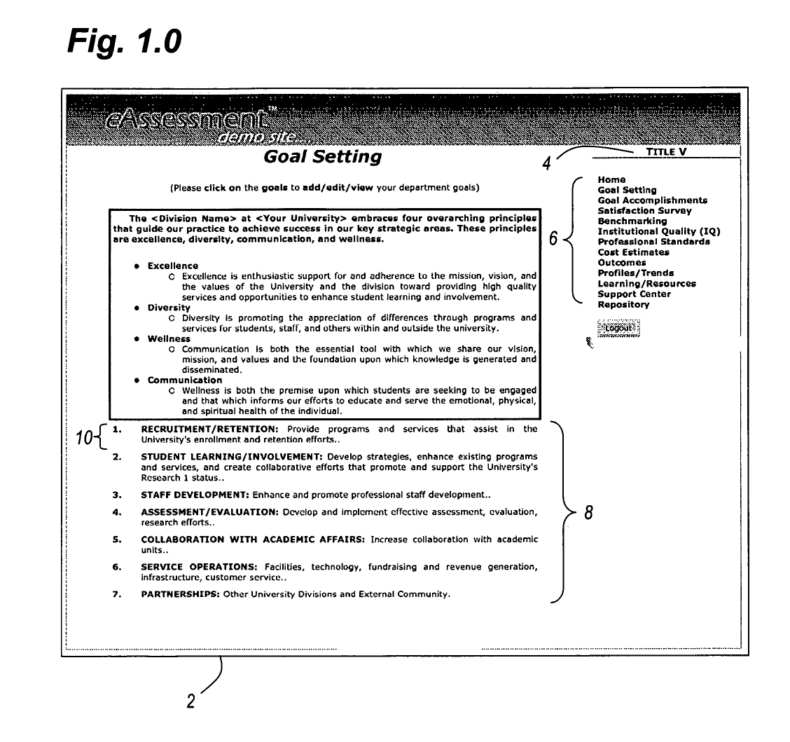

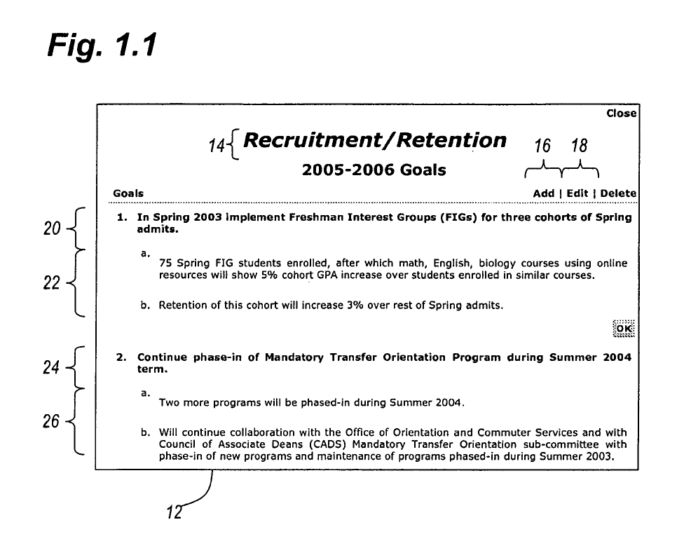

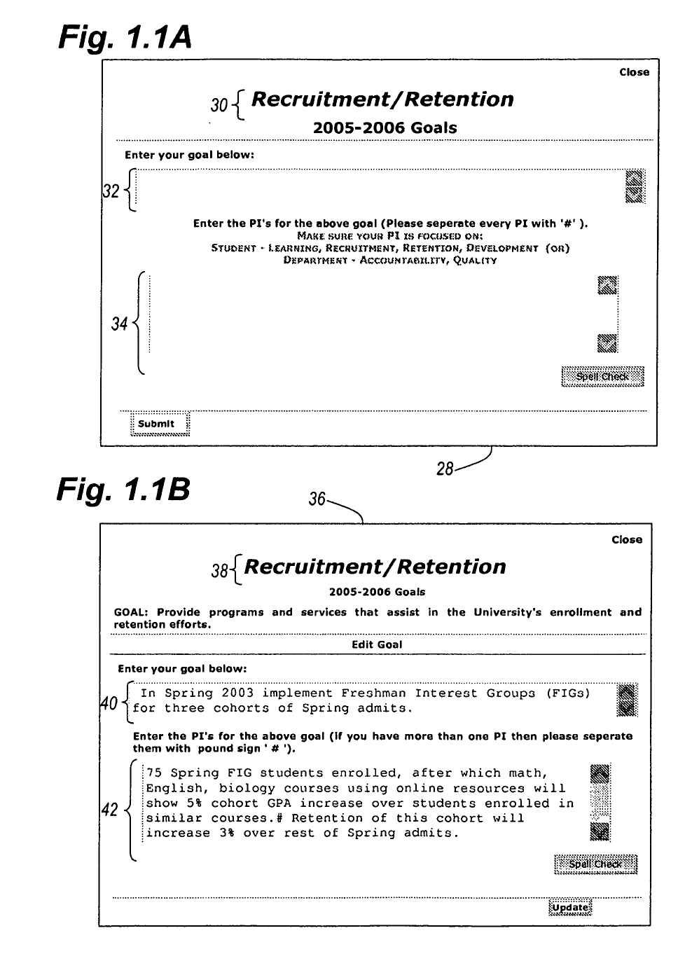

FIG. 1.0 shows a representative example of a goal setting input screen 2. The upper right hand corner of the input screen 2 displays the educational department designation 4 selected to receive input in this assessment process. In this instance, the representative department is “Title V”. Beneath the department designation 4 is a list of submenus 6 for use during the assessment process. The active submenu for FIG. 1.0 is the “Goal Setting” submenu. At the bottom of the input screen 2, are a number of goal categories 8, or key strategic areas of an educational institution. Reference number 10 illustrates a single exemplary goal category of “Recruitment/Retention”.

FIG. 1.1 shows a representative example of a goal setting and viewing screen 12 after a user has selected a goal category from FIG. 1.0. In this example, a user has selected the “Recruitment/Retention” goal category 14. On this input screen, goals can be added via the selection of the “Add” selection button 16, or edited via a selection of the “Edit” selection button 18. Reference number 20 illustrates a previously input goal, and reference number 22 illustrates a number of previously input performance indicators associated with the goal 20. The goal setting input screen 12 is able to additionally display any and all additional goals 24 and performance indicators 26 associated with those goals.

FIG. 1.1A shows a representative example of a goal adding screen 28 after a user has selected the “Add” selection button 16 as shown in FIG. 1.1. The general goal category 30 is displayed at the top of the goal adding screen 28 in addition to a goal input area 32 and a performance indicator (PI) input area 34.

FIG. 1.1B shows a representative example of a goal editing screen 36 after a user has selected the “Edit” selection button 18 as shown in FIG. 1.1. The general goal category 38 is displayed at the top of the goal editing screen 36 in addition to a goal editing area 40 and a performance indicator editing area 42.

From each of the above goal input and editing screens, a user may input goals and performance indicators into the assessment tool for storage in the assessment tool memory and for later review, editing or processing.

### II. Goal Accomplishment

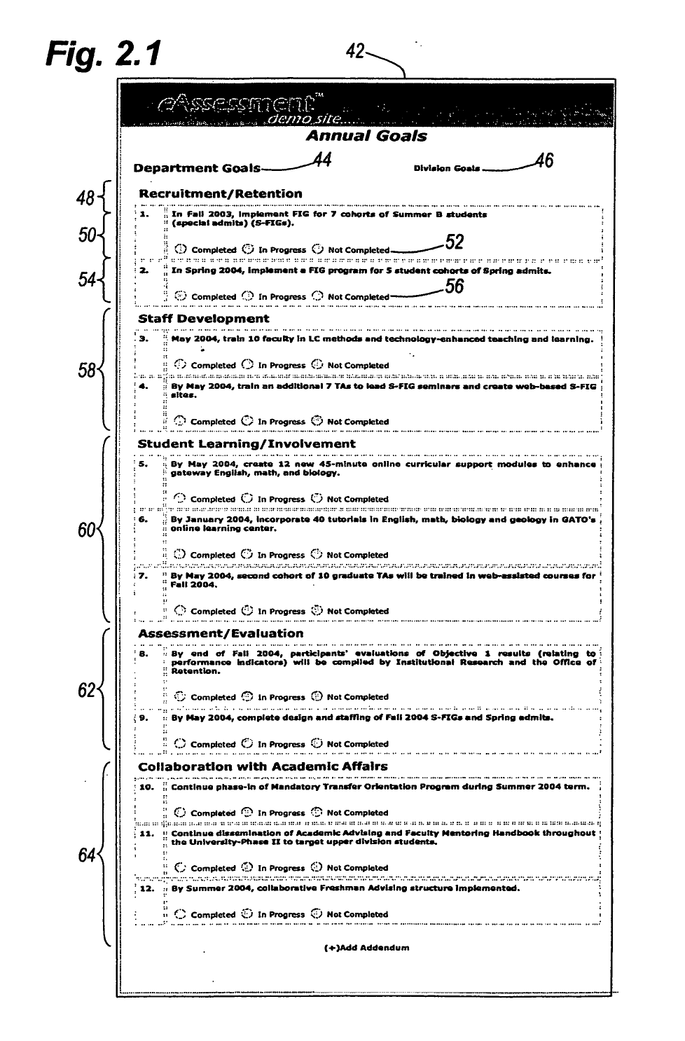

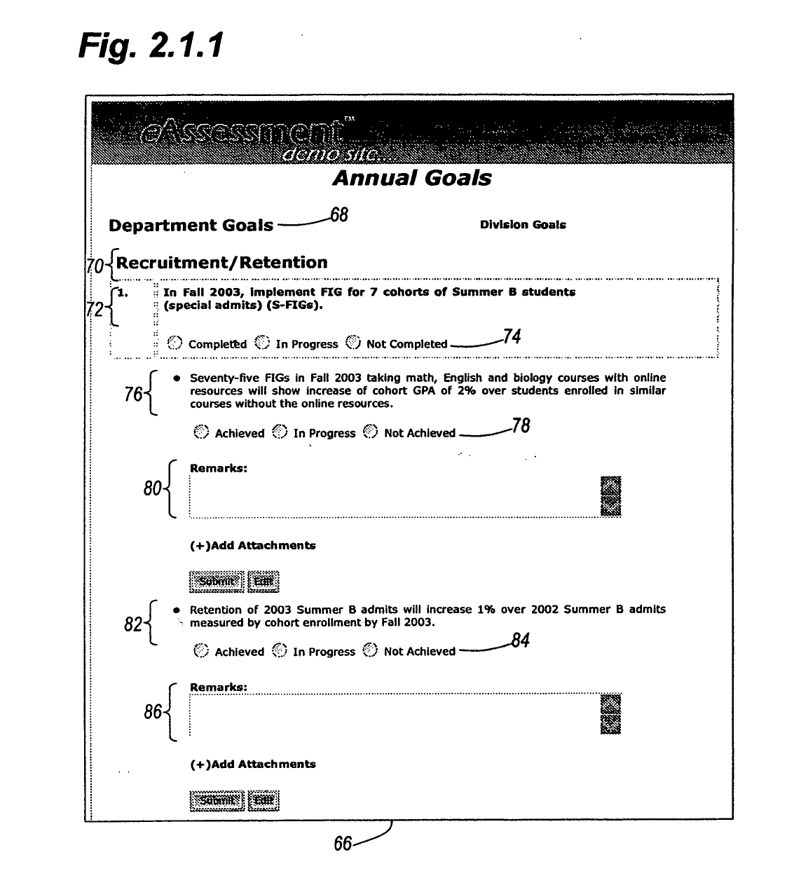

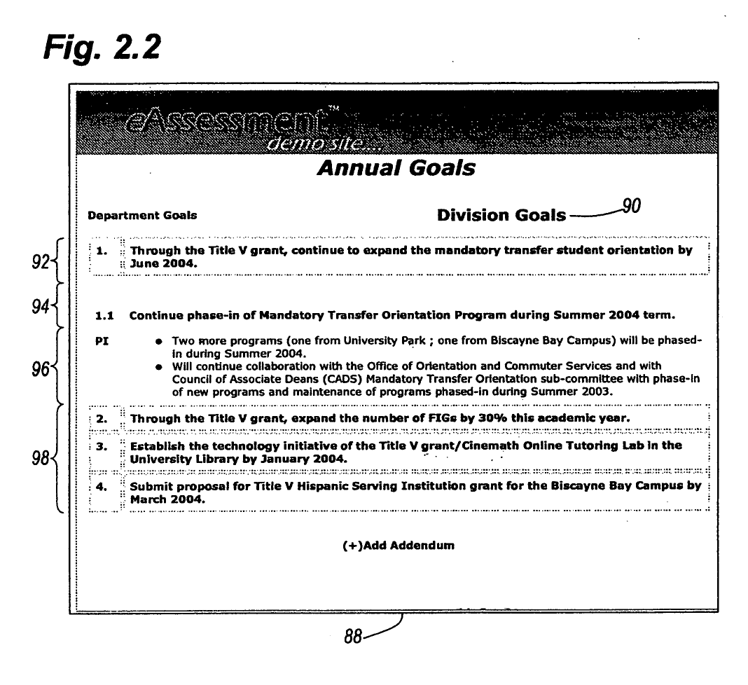

FIG. 2.1 shows a representative example of the goal accomplishment screen 42 selected by a user choosing the “Goal Accomplishments” selection button under submenu 6 of FIG. 1.0. Goal accomplishment screen 42 may be divided into two a general submenus based on the origination and focus of the goals, for example, department goals 44 and division goals 46. In this example, department goals 44 has been selected such that a user may review the previously input goals and evaluate their progress. A general goal category of “Recruitment/Retention” 48 lists a first 50 goal and a level of completion rating input section 52 whereby a user may rate of progress of the goal as being “Completed”, “In Progress”, or, “Not Completed”. Each successive goal 54 has its own level of completion rating input section 56 designed for a user's input. Subsequent general goal categories 58, 60, 62 and 64 illustrate the display of multiple goals and corresponding level of completion rating input sections.

FIG. 2.1.1 shows a representative example of a goal accomplishment screen 66 that additionally allows all performance indicators to be viewed. The general submenu “Department Goals” 68 is selected to show an emerging theme of “Recruitment/Retention” 70 having a first goal 72 and a level of completion input section 74, as previously described above. A performance indicator 76 additionally has a level of achievement input section 78, whereby a user may select “Achieved”, “In Progress”, or “Not Achieved” to designate a level of achievement of any performance indicator. A text input section 80 may additionally accommodate description from a user with respect to each performance indicator achievement or goal completion. Additional performance indicators 82, level of achievement input selection 84 and text input section 86 may accompany multiple performance indicators for a specific goal 72.

FIG. 2.2 shows a representative example of a goal accomplishment screen 88 for the general submenu of “Division Goals” 90. Here, a division general goal category 92 is displayed with a department goal 94 and its accompanying performance indicators 96. Multiple division goals categories 98 are displayed such that a user may select any category and its related department goals and performance indicators to record levels of completion and levels of achievement.

### III. Satisfaction Survey

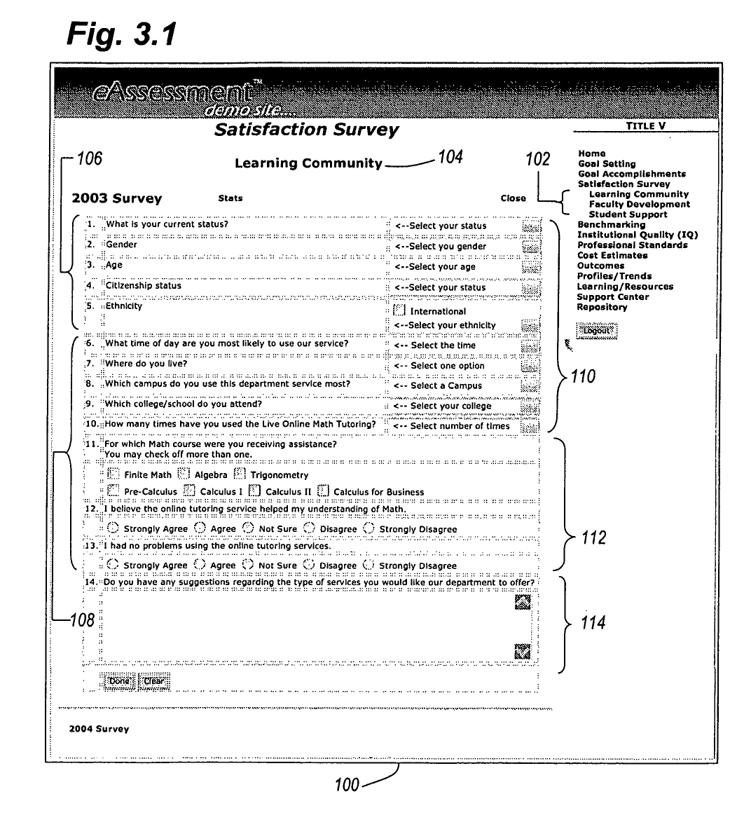

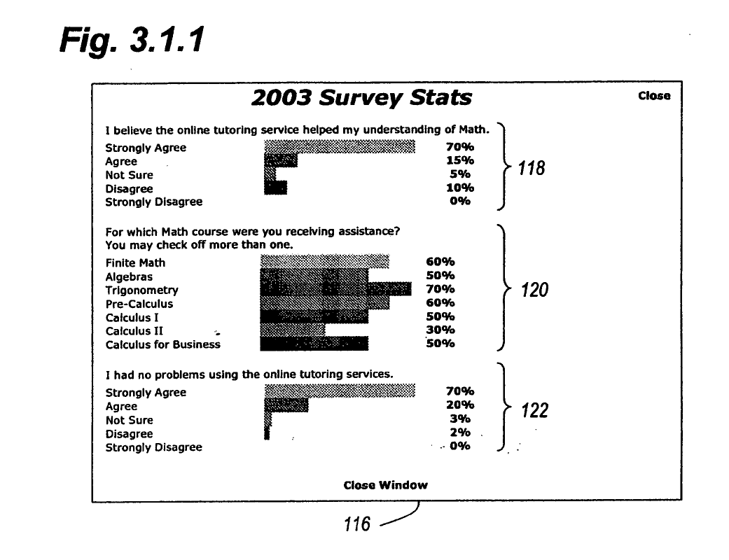

FIG. 3.1 shows a representative example of a satisfaction survey 100 selected from a group of functional areas 102 of a department of an educational institution. In this example, the user has selected the functional unit of “Learning Community” 104. The survey has been designed by a department to receive feedback data from those who benefit and are served by the department's services. A first series of questions 106 are directed to receiving personal data from the survey taker and a second series of questions 108 are directed to receiving educationally related survey data. A survey taker may respond to the satisfaction survey in any number of ways. For example, a pre-selected pull-down response menu 110, checkboxes 112, or text input from a user 114.

FIG. 3.1.1 shows a representative example of a composite satisfaction survey 116 compiled from data received from user's feedback to the satisfaction survey 100. Specific questions 118, 120, 122 from the satisfaction survey may be displayed with a statistical presentation of the responses received for each specific question or category. Additionally, the educational institution may use demographic data collected from the survey for display.

### IV. Benchmarking

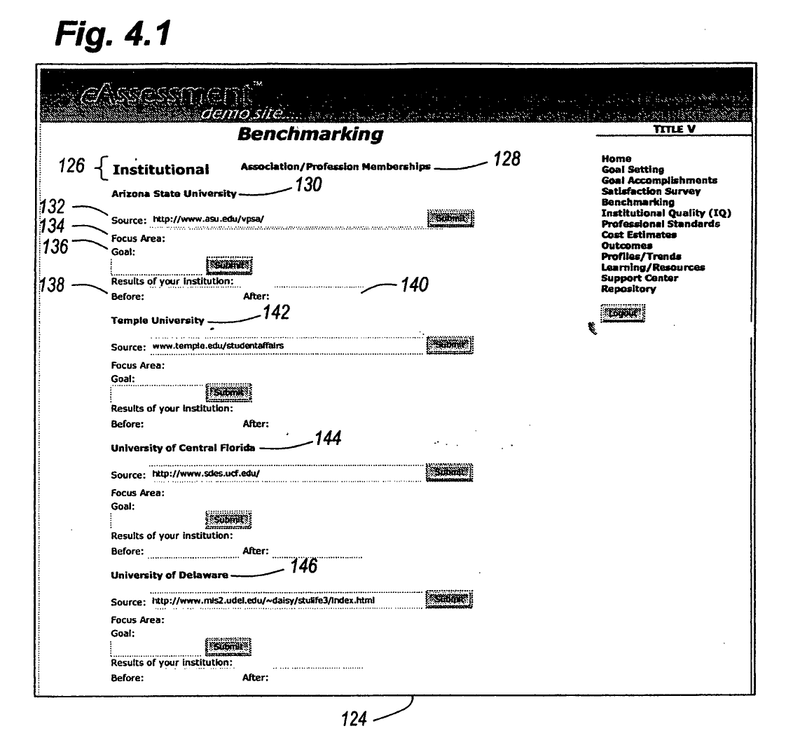

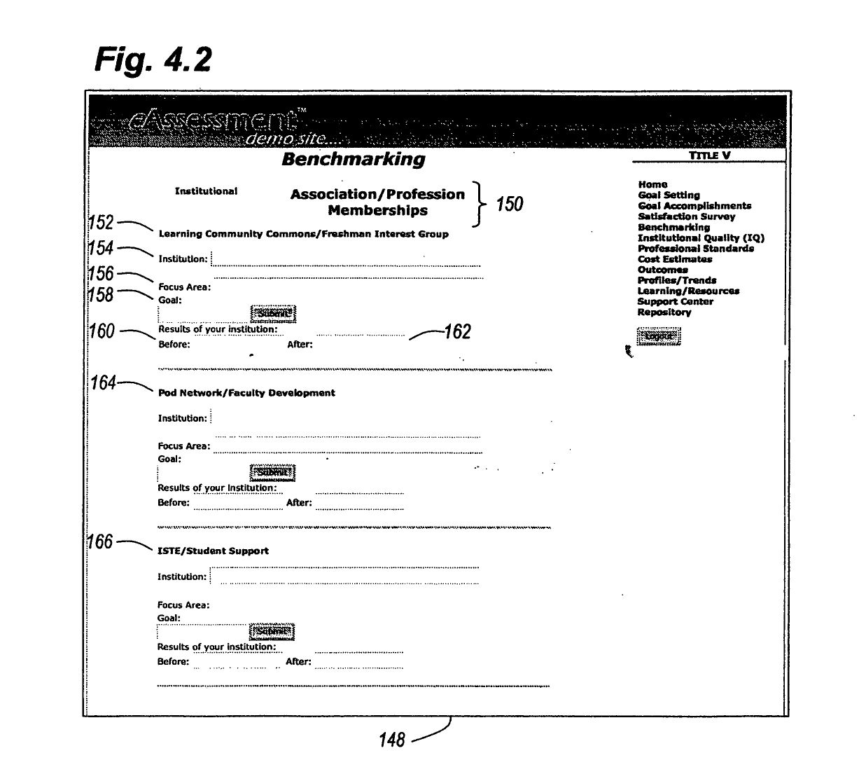

FIG. 4.1 shows a representative example of an institutional benchmarking input screen 124. The benchmarking section may be divided into submenus based on the type of benchmarking the educational institution department finds most suitable for comparison. A first example is establishing benchmarking criteria against another educational institution 126, and a second example is to establish benchmarking criteria against associations or professional membership organizations 128 of another institution. An educational institution is selected for comparison with the educational institution performing the assessment. In this example, Arizona State University 130 is selected and source data for the comparison 132 input. A focus area 134 that defines a specific service area having quantifiable result data is input into the assessment tool. A goal 136 is input and quantifiable results for a first period of time 138 are input and a data input field for inputting quantifiable results for a second and later period of time of 140 is provided. Additional educational institutions 142, 144, 146 are able to be input with focus areas and quantifiable data input for each.

FIG. 4.2 shows a representative example of an association/professional organization benchmarking input screen 148. In this example, an association or professional membership association 150 is selected for comparison with the educational institution performing the assessment. Here, a first association 152 is selected for comparison and a corresponding institution 154 having source data for the comparison. A focus area 156 that defines a specific service area having quantifiable result data is input into the assessment tool. A goal 158 is input and quantifiable results for a first period of time 160 are input and a data input field for inputting quantifiable results for a second and later period of time of 162 is provided. Additional associations or professional membership associations 164, 166 are able to be identified with respect to their institutions and focus areas, and quantifiable data is then input for each.

### V. Institutional Quality

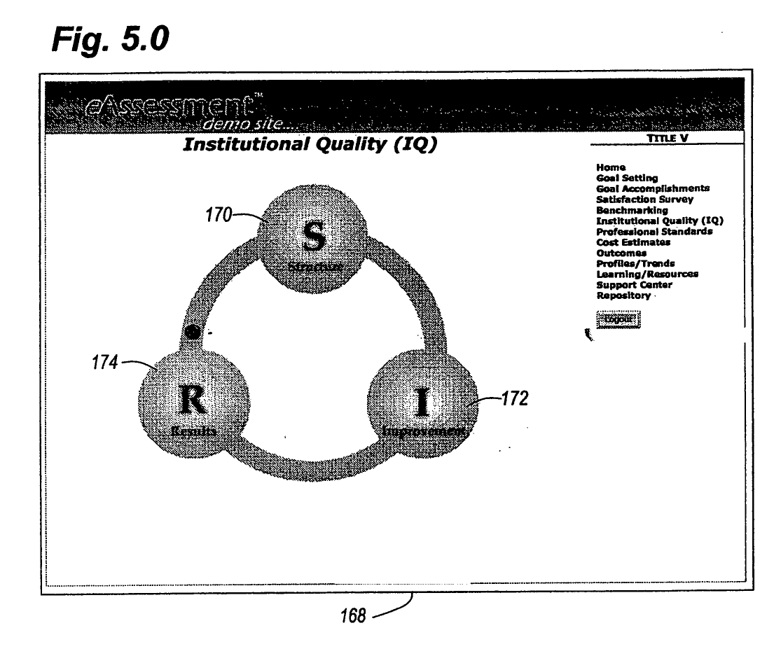

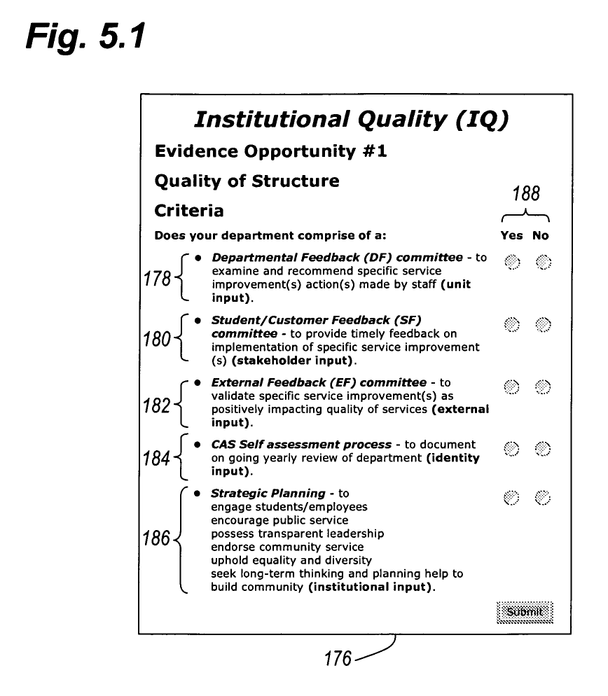

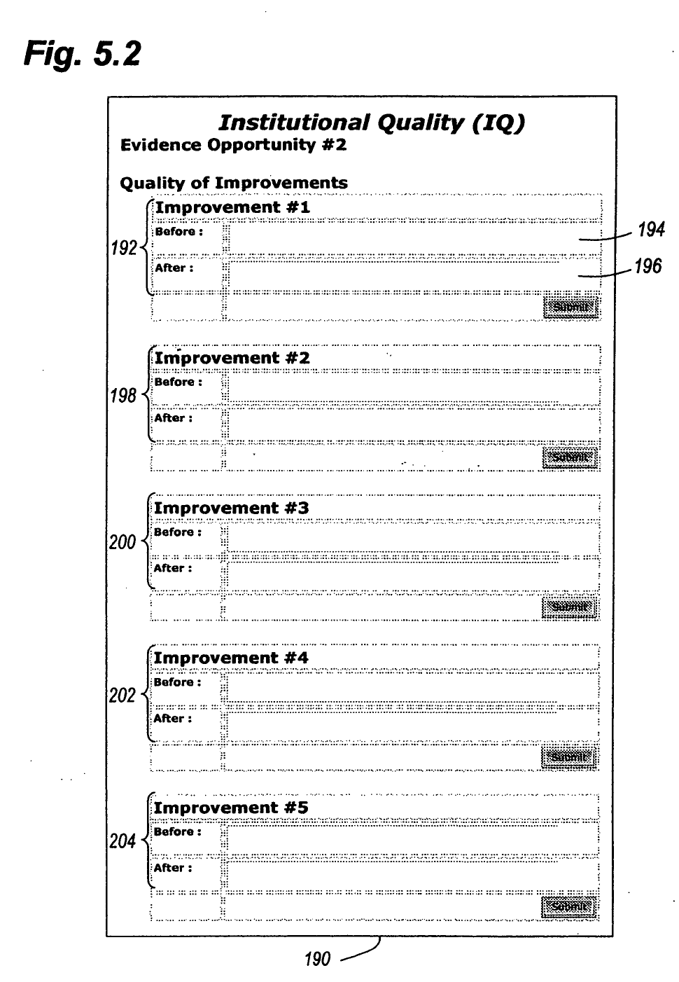

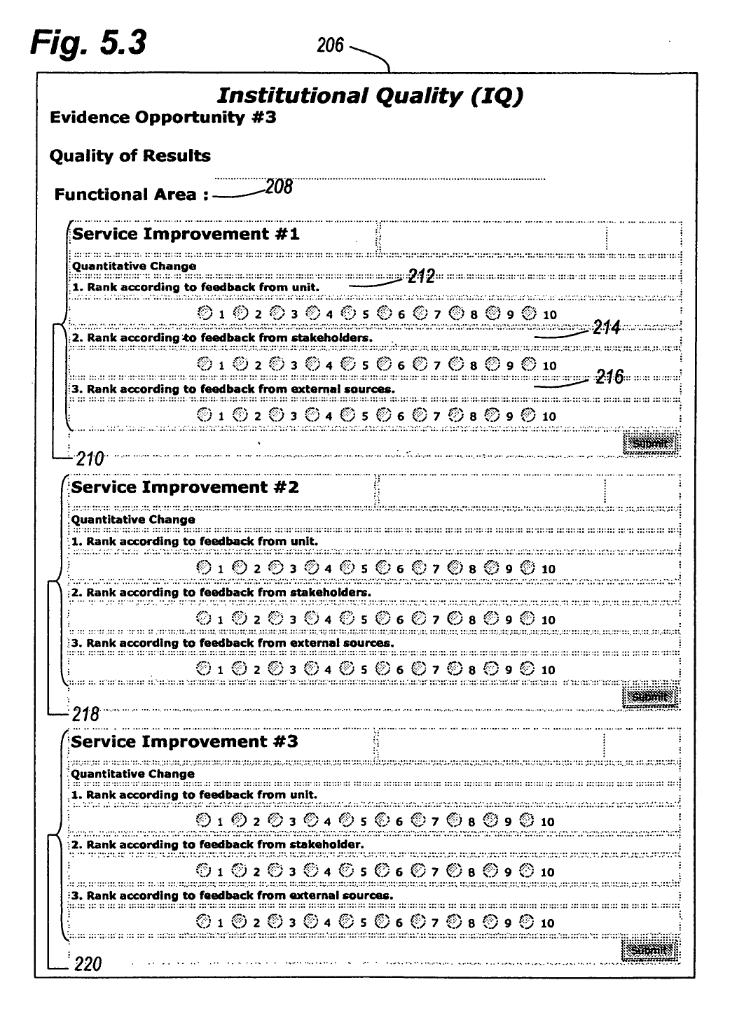

FIG. 5.0 shows a representative example of an institutional quality menu screen 168 having three sections, a structure section 170, an improvement section 172, and a results section 174. Each of these sections will be described herein below in further detail.

FIG. 5.1 shows a representative example of a “Quality of Structure” survey menu 176. A list of departmental quality functions 178, 180, 182, 184, 186 consisting of committees, standardize processes and planning processes prompt a user to respond in a “yes” or “no” fashion 188 as to the existence of these quality functions in the educational department being assessed. The purpose of this departmental quality functions survey is to inform the division managers of the existence or lack of these quality functions within an educational institution department.

FIG. 5.2 shows a representative example of a “Quality of Improvements” screen 190. Department improvements 192, 198, 200, 202, 204 are input of qualitative results for a first period in time 194 and a second period in time 196 are input for each department improvement.

FIG. 5.3 shows a representative example of a “Quality of Results” screen 206. On this screen, a functional area 208 is selected and identified. A first department service improvement 210 is identified and a quantitative survey prompts certain categories of users to input a quantitative value related to the service improvement. Quantitative values may be solicited responses from the department itself 212, from stakeholders having a vested interest in the department 214, and external sources doing business with the department 216. Multiple service improvements 218, 220 in the same functional area may be displayed and the response data may be compiled for further analysis.

### VI. Professional Standards

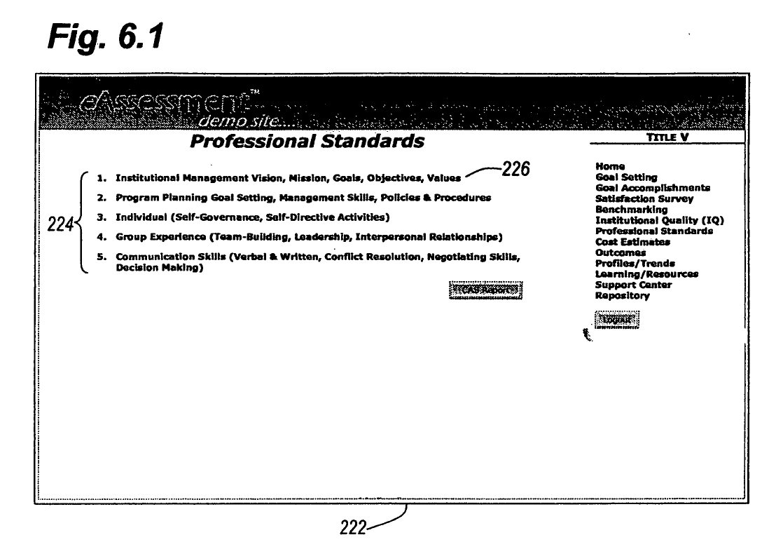

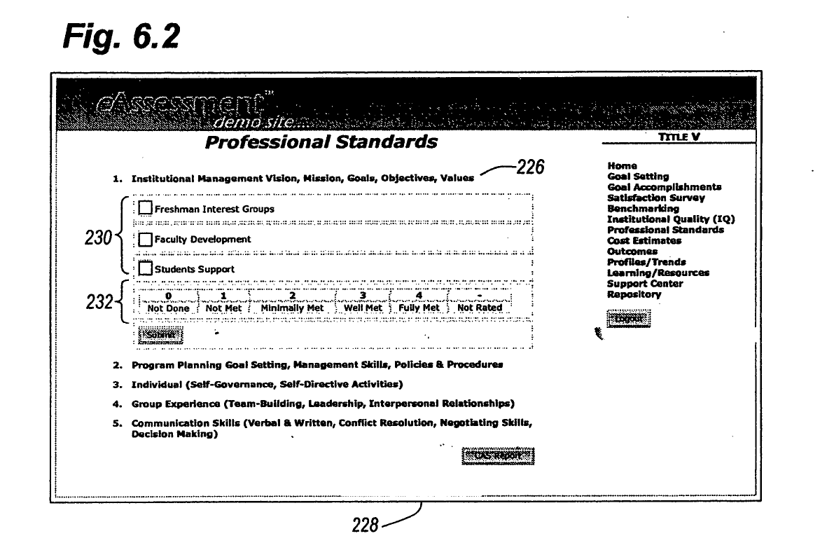

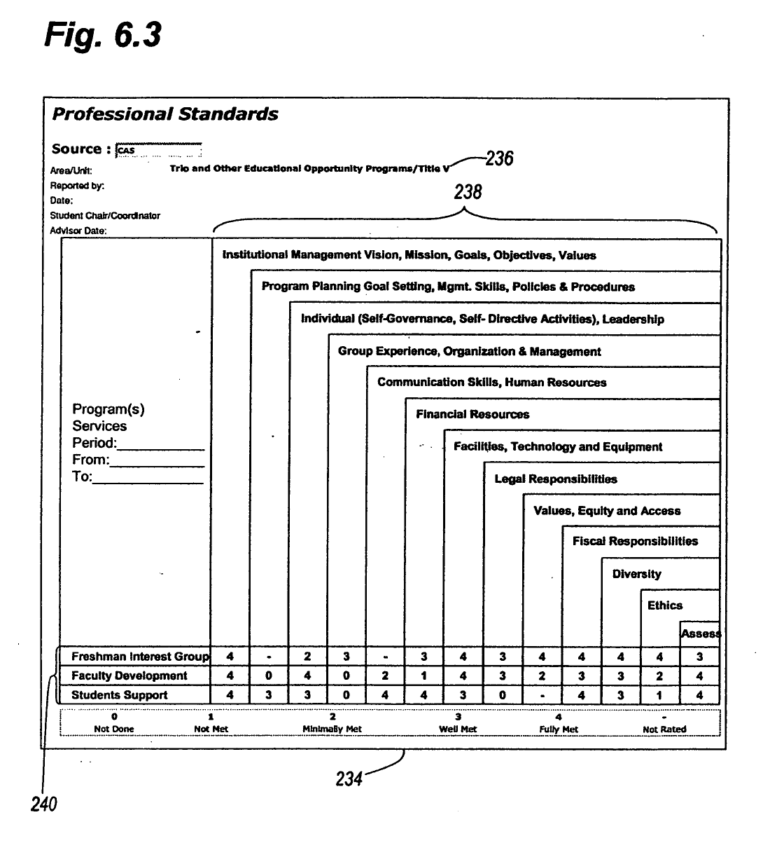

FIG. 6.1 shows a representative example of a professional standards main menu screen 222. A representative sample of professional standards 224 are listed for a user to select and begin to rate a department based on a number of criteria. The example used for professional standards comes from The Book of Professional Standards for Higher Education written by the Council for the Advancement of Standards in Higher Education (CAS). A user would, for example, select a professional standard 226 from the list of sample professional standards 224.

FIG. 6.2 shows a representative example of a professional standards menu screen 228 after the selection of a first professional standard 226. A number of functional areas within a department 230 appear with respect to the first professional standard 226. Each of these functional areas 230 have an input section allowing a user to rate each functional area with respect to a grading legend 232. In this instance, for example, the grading scale is a numerical value from 0 to 4. After a user has rated the functional areas within the department 230, the user may continue to select different professional standards to rate each of the functional areas of the department.

FIG. 6.3 shows a representative example of a professional standards output table 234. Reference number 236 identifies the functional area of the department that has performed the rating. Reference number 238 identifies each of the professional standards used in the rating process and the rated functional areas 240 display an average rating given for each professional standard.

VII. Cost Estimates

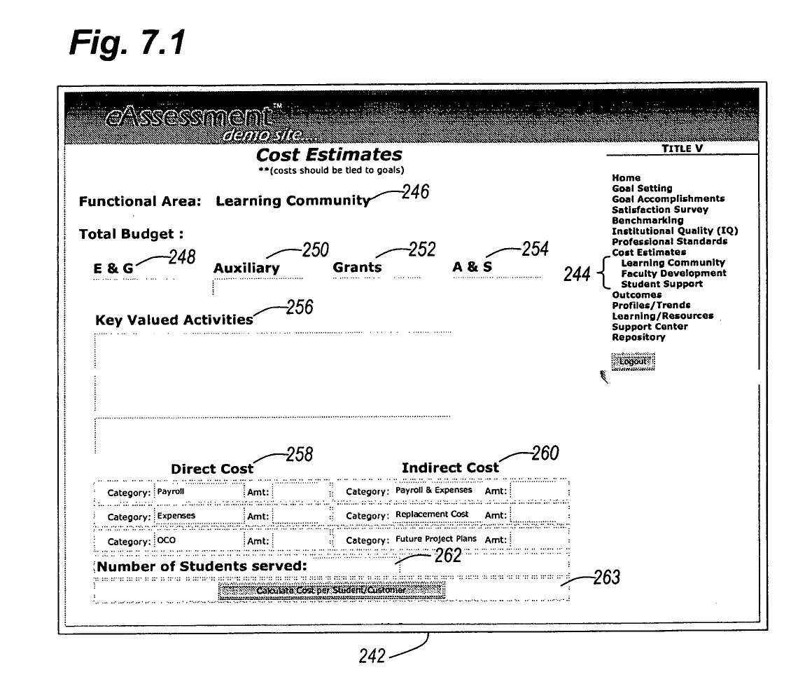

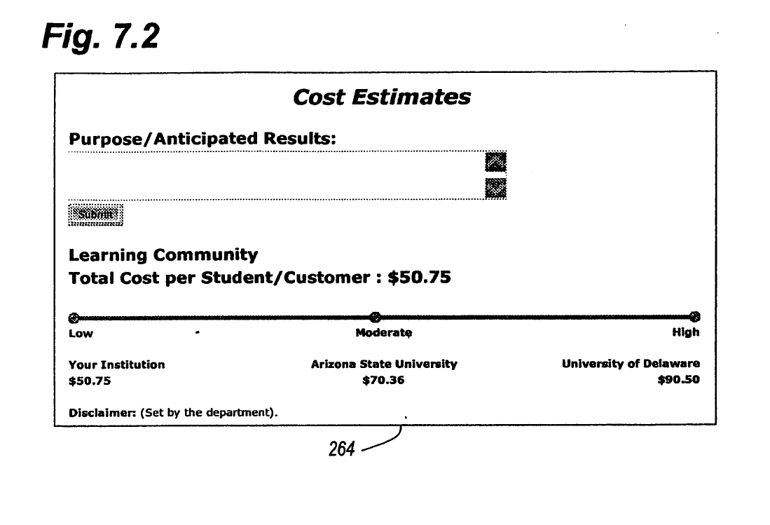

FIG. 7.1 shows a representative example of a cost estimate screen 242. A user first selects a functional unit of a department of an educational institution from a list of functional units 244. On the screen, the functional unit that is selected is displayed 246. The user then inputs key valued activities 256 that are essential to the functional units previously selected. Next, the user inputs cost estimates values for educational and general expenditures (E & G) 248, auxiliary revenue 250, grant revenue 252, and activity and services revenue (A & S) 254. A user then inputs direct costs 258 and indirect costs 260 for the functional unit of the department. Finally, the user inputs the number of students served 262 by the functional unit of the department. A computer program then calculates a total cost per student served value based on a sum of all estimated budget amounts divided by the total number of students served 263.

FIG. 7.2 shows a representative example of a cost estimate display output screen 264 showing the computed total cost per student served value in comparison with other total cost per student served values of similar key valued activities of functional units of other educational institutions for which data has already been provided. In this case, the institution is represented on a graphical linear scale from low to high with the other educational institutions.

VIII. Outcomes

The outcomes portion of the invention collects all previously input data from the assessment data collecting categories and displays the data in either a quantitative and/or a qualitative output format.

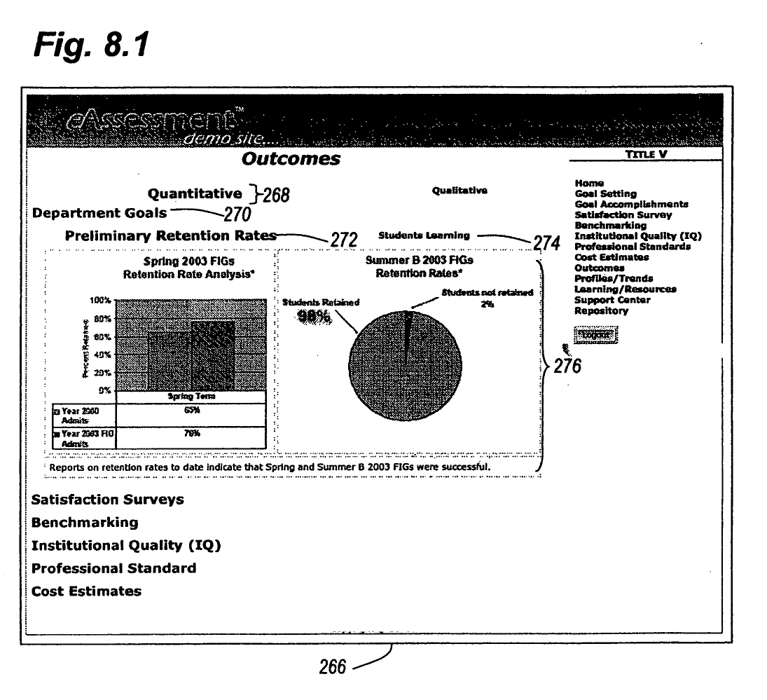

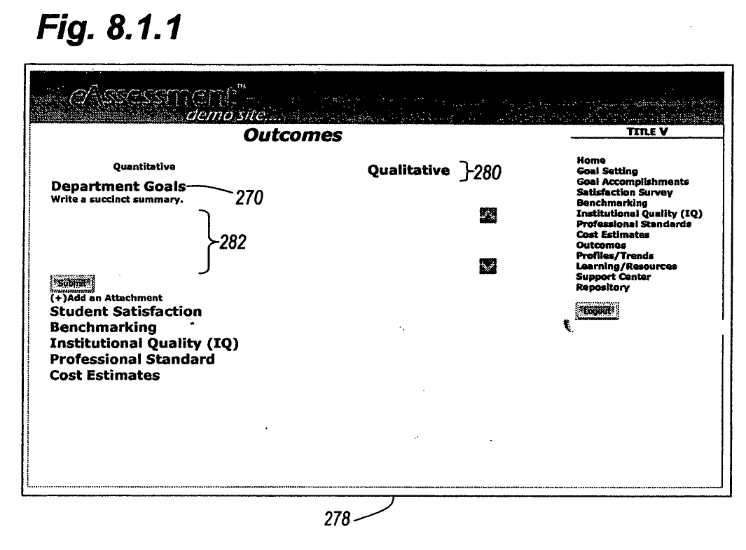

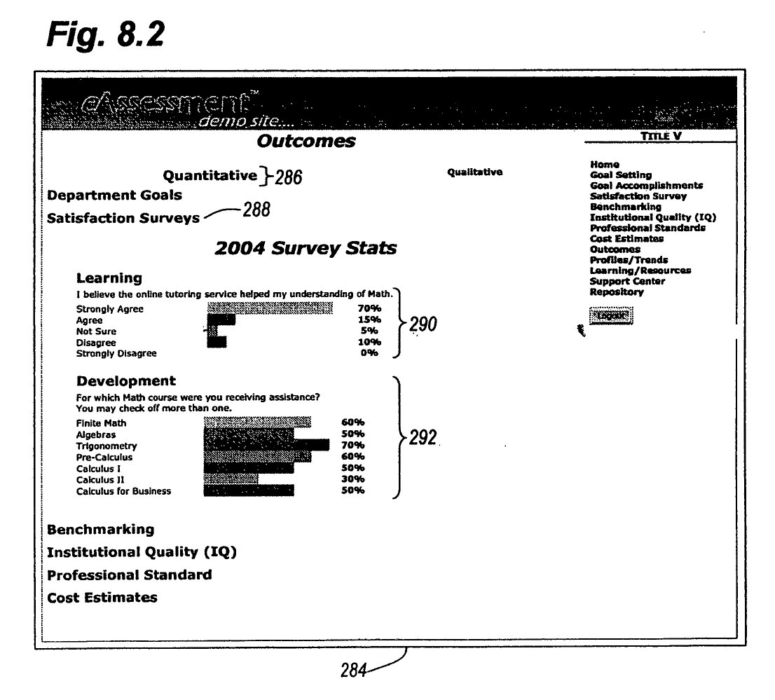

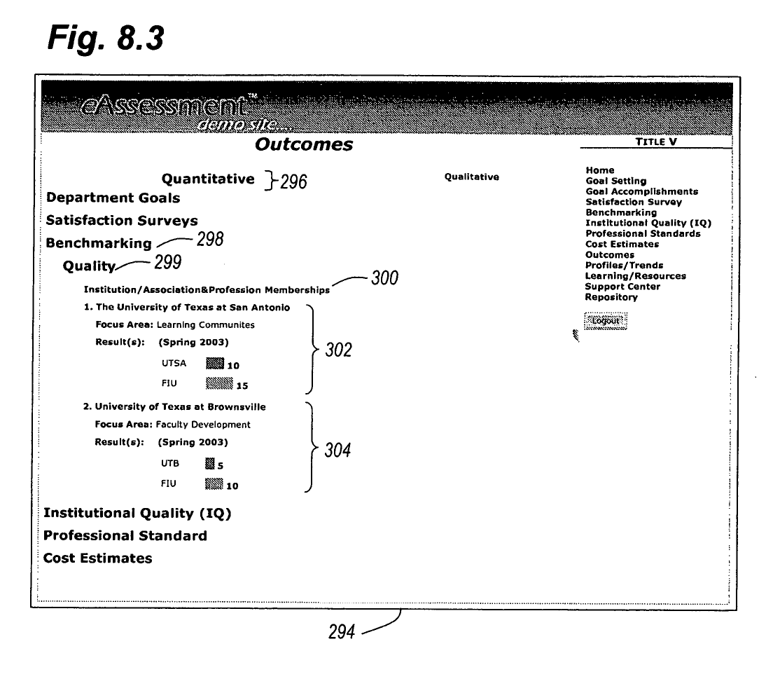

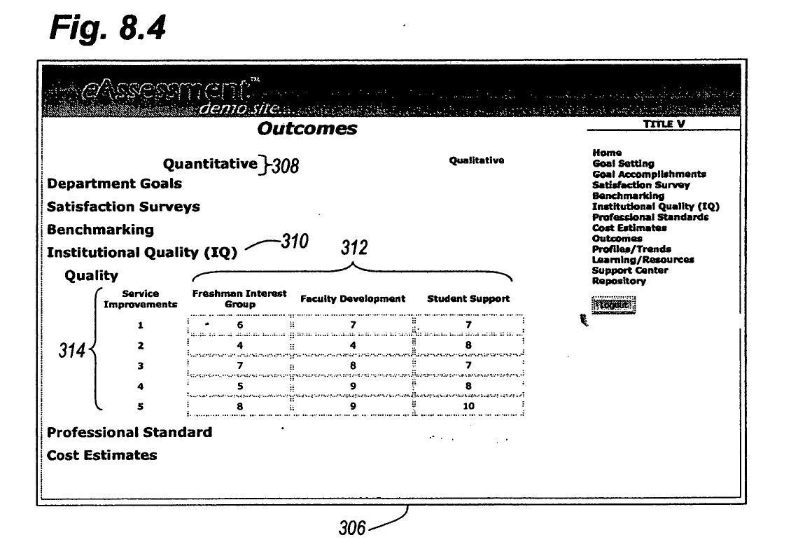

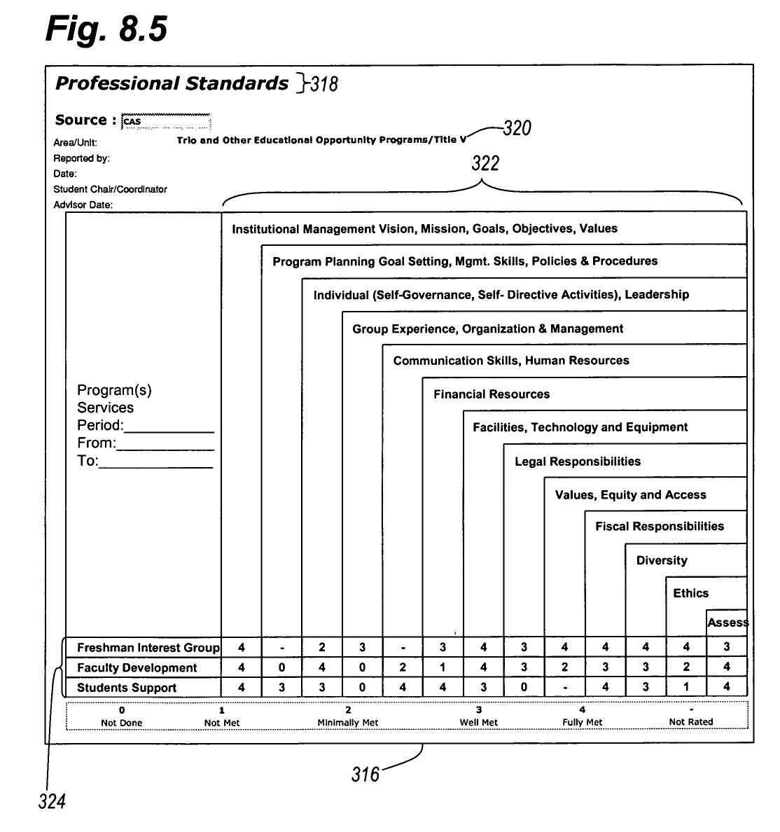

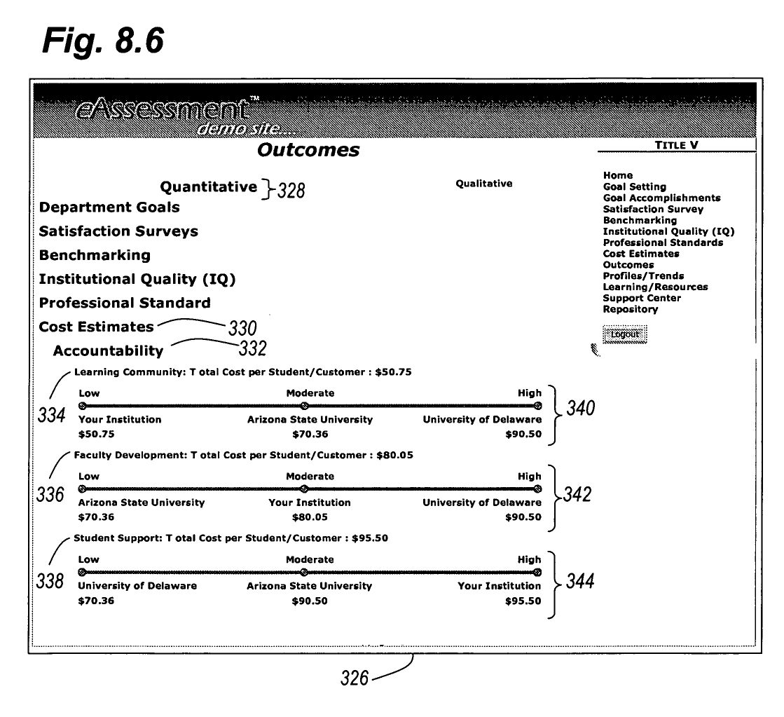

FIG. 8.1 shows a representative example of an outcomes screen for previously input department goals 266. In this instance, a quantitative 268 portion of the outcomes section and department goals 270 has been selected. Merging themes 272, 274 may be selected by the user to display graphical data 276. This graphical data is generated either automatically or manually by the data collected in the goal setting and goal accomplishments section of the present invention.

FIG. 8.1.1 shows a representative example of an outcomes screen for previously input department goals 278 where a qualitative 280 portion of the outcomes section and department goals 270 has been selected. A text summary 282 may be input in the qualitative outcomes section to further identify or chronicle any pertinent information in the quantitative section. The quantitative and qualitative sections may be selected for each of the assessment data collecting categories.

FIG. 8.2 shows a representative example of an outcomes screen for previously input satisfaction surveys 284. After the user selects the quantitative 286 portion of the outcomes screen, and the satisfaction surveys 288 portion, a graphical representation of the tabulated data from the previously input satisfaction surveys are displayed. Each category of the satisfaction survey 290, 292, as previously described above, may be graphically displayed showing a statistical representation of the responses received to the satisfaction surveys.

FIG. 8.3 shows a representative example of an outcomes screen for previously input benchmarking data 294. After the user selects the quantitative 296 portion of the outcomes screen, and the benchmarking 298 portion, graphical representations of the tabulated data from the previously input benchmarking surveys and merging theme 299 are displayed. In this example, the Institution/Association & Professional Memberships 300 are identified in combination with the educational institution for comparison, the focus area of the benchmarking data, and the result data of the assessed institution in comparison with the other educational institution 302, 304.

FIG. 8.4 shows a representative example of an outcomes screen for previously input institutional quality data 306. After the user selects the quantitative 308 portion of the outcomes screen, and the institutional quality (IQ) 310 portion, a graphical representation of the tabulated data from the previously input institutional quality surveys is displayed. In this example, the functional units 312 of the surveyed department are grouped as columns in a table, and these previously input service improvements 314 identified on the left-hand portion of the table for each functional unit.

FIG. 8.5 shows a representative example of an outcomes screen for previously input professional standards data 316. After the user selects the professional standards of 318 portion of the outcomes screen, the functional unit or department 320 is either selected or displayed. The professional standards 322, as previously mentioned above, are identified and correlate to the functional units 324 of the department of the educational institution. Input data are displayed for each functional unit of the department with respect to each of the categories of the professional standards.

FIG. 8.6 shows a representative example of outcomes screen for previously input cost estimate data 326. After the user selects the quantitative 328 outcomes portion and the cost estimates 330 portion, the user either selects or has displayed a merging theme 332 as previously input. Each functional unit of the department 334, 336, 338 is displayed and a linear graph 340, 342, 344 is associated with each functional unit showing the assessed institution in relationship to at least one other educational institution on a total cost per student value basis.

It is to be understood that the present invention is not limited to the embodiment described above, but encompasses any and all embodiments within the scope of the following claims.

I claim:

1. A method of using an assessment tool for an educational institution, said assessment tool to be carried out on a computer having a memory, processor and an intranet connection, said educational institution having a plurality of divisions, each of said plurality of divisions having a plurality of departments, and each of said plurality of departments having a plurality of functional units, said method of using an assessment tool comprising the steps of:
A) inputting a plurality of goal categories, said plurality of goal categories defining key strategic areas of a department or a division within an educational institution, selecting at least one of said plurality of goal categories, inputting at least one goal for said selected at least one of said plurality of goal categories, and inputting at least one performance indicator related to said input at least one goal;
B) selecting said at least one goal, inputting a level of completion for said at least one goal, and inputting a level of achievement for said at least one performance indicator related to said at least one goal; and
C) selecting at least one functional unit within a department, creating a survey for at least one category of individuals served by said at least one functional unit, receiving feedback data from said at least one category of individuals in response to said survey, and compiling said received feedback data into a composite survey.

2. The method of using an assessment tool for an educational institution of claim 1, further comprising the step of:
editing said at least one goal for said selected at least one of said plurality of categories.

3. The method of using an assessment tool for an educational institution of claim 1, wherein said at least one goal is selected from the group consisting of:
an educational institution department goal; and
an educational institution division goal.

4. The method of using an assessment tool for an educational institution of claim 1, wherein said step of creating a survey for said at least one category of individuals served by said at least one functional unit further comprises the steps of:
creating general demographic data survey questions;
creating department specific questions; and
creating functional unit specific questions.

5. The method of using an assessment tool for an educational. institution of claim 1, further comprising the step of outputting for display a quantitative data presentation based on:
said inputted goals and said levels of completion for each of said goals; and
said composite survey compiled from said feedback data received from said at least one category of individuals in response to said survey for each functional unit.

6. The method of using an assessment tool for an educational institution of claim 1, further comprising the steps of:
selecting at least one other educational institution for comparison;
inputting a focus area defining a specific service area of said selected at least one other educational institution having previous quantifiable results;
inputting said previous quantifiable results for said specific service area of said selected at least one other educational institution; and
inputting quantifiable results for said specific service area for said educational institution for a first period of time.

7. The method of using an assessment tool for an educational institution of claim 6, further comprising the step of:
inputting quantifiable results for said specific service area for said educational institution for a second later period of time.

8. The method of using an assessment tool for an educational institution of claim 6, further comprising the step of:
outputting for display a quantitative data presentation based on said previous quantifiable results for said specific service area of said selected at least one other educational institution in comparison with said quantifiable results for said specific service area for said educational institution for said first period of time.

9. The method of using an assessment tool for an educational institution of claim 1, further comprising the step of:
selecting at least one association or professional organization;
selecting at least one other educational institution having an equivalent at least one association or professional organization for comparison;
inputting a focus area defining a specific service area of said selected at least one other educational institution having previous quantifiable results;
inputting said previous quantifiable results for said specific service area of said selected at least one other educational institution; and
inputting quantifiable results for said specific service area for said educational institution for a first period of time.

10. The method of using an assessment tool for an educational institution of claim 9, further comprising the step of:
inputting quantifiable results for said specific service area for said educational institution for a second later period of time.

11. The method of using an assessment tool for an educational institution of claim 9, further comprising the step of:
outputting for display a quantitative data presentation based on said previous quantifiable results for said specific service area of said selected at least one other educational institution in comparison with said quantifiable results for said specific service area for said educational institution for said first period of time.

12. The method of using an assessment tool for an educational institution of claim 1, further comprising the steps of:
generating a list of departmental quality functions selected from the group consisting of a committee, a standardized process and a planning process;
prompting a response determine the existence of each of said departmental quality functions; and
receiving a user response based on said step of prompting.

13. The method of using an assessment tool for an educational institution of claim 12, further comprising the steps of:
inputting at least one department improvement;
inputting first qualitative results for said at last one department improvement for a first period of time; and
inputting second qualitative results for said at least one department improvement for a second later period of time.

14. The method of using an assessment tool for an educational institution of claim 13, further comprising the steps of:
inputting a functional area defining an area of service of said department;
displaying said at least one department improvement;
receiving input of a quantitative survey value for said at least one department improvement from individuals within said functional area, stakeholders of said functional area, and individuals external to said functional area; and
compiling said input quantitative survey values.

15. The method of using an assessment tool for an educational institution of claim 14, further comprising the step of:
outputting for display a quantitative data presentation based on said compiled quantitative survey values corresponding to each of said functional areas and department improvements.

16. The method of using an assessment tool for an educational institution of claim 1, further comprising the steps of:
selecting one of a plurality of predetermined professional standards;
selecting at least one functional unit of a department to rate according to said selected one of a plurality of predetermined professional standards;
inputting a quantitative rating for said selected at least one functional unit according to said selected one a plurality of predetermined professional standards;
tabulating said input quantitative rating; and
generating an output table based on said tabulated input quantitative ratings.

17. The method of using an assessment tool for an educational institution of claim 16, further comprising the step of:
outputting for display a quantitative data presentation based on said output table based on said tabulated input quantitative ratings.

18. The method of using an assessment tool for an educational institution of claim 1, further comprising the steps of:
selecting a functional unit of a department;
selecting at least one key valued activity related to said functional unit of said department;
inputting estimated budget amounts for said key valued activity selected from the group consisting of educational and general expenditures (E & G), auxiliary revenue, grant revenue, and activities and services (A & S) revenue;
inputting direct and indirect cost estimates for said key valued activity;
inputting a total number of students served by said key valued activity;
calculating a total cost per student served value based on the sum of all estimated budget amounts divided by said total number of students served; and
displaying said calculated total cost per student served value in comparison with another educational institution's total cost per student served value with respect to said key valued activity.

19. The method of using an assessment tool for an educational institution of claim 18, further comprising the step of:
outputting for display a quantitative data presentation based on said calculated total cost per student served value for each of said functional areas of said department.
